(19) United States
(12) Patent Application Publication
(10) Pub. No.: US 2022/0078086 A1
(43) Pub. Date: Mar. 10, 2022

(54) SYSTEMS AND METHODS FOR DATACENTER CAPACITY PLANNING

(71) Applicant: Dell Products, L.P., Round Rock, TX (US)

(72) Inventors: Jimmy M.S., Kollam (IN); Vinutha V, Bangalore (IN)

(73) Assignee: Dell Products, L.P., Round Rock, TX (US)

(21) Appl. No.: 17/012,147

(22) Filed: Sep. 4, 2020

(51) Int. Cl. H04L 12/24

(52) U.S. Cl. CPC H04L 41/12

(57) ABSTRACT

Systems and methods for datacenter capacity planning are described. In some embodiments, an Information Handling System (IHS) may include a processor and a memory coupled to the processor, the memory having program instructions stored thereon that, upon execution, cause the IHS to: receive user input; and suggest a location for placement of a device in a selected rack of a datacenter based on the user input, where the suggested location takes into account at least one of: (a) device clustering, or (b) network port availability.

### FIELD

This disclosure relates generally to Information Handling Systems (IHSs), and more specifically, to systems and methods for datacenter capacity planning.

### BACKGROUND

As the value and use of information continue to increase, individuals and businesses seek additional ways to process and store it. One option available to users is Information Handling Systems (IHSs). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated.

Variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Groups of IHSs may be housed within data center environments. A data center may include a large number of IHSs, such as servers that are installed within chassis and stacked within slots provided by racks. A data center may include large numbers of such racks that may be organized into rows.

Precise placement of IHSs in a data center has become an important aspect to improve their overall utilization. As the inventors hereof have recognized, however, although conventional IHS placement solutions may consider historical power and thermal metrics, as well as space capacity, they do not consider other critical parameters such as network port availability, grouping of servers in case of clusters, etc.

Accordingly, to facilitate the deployment, placement, and management of IHSs in a new or existing data center, the inventors hereof have developed various embodiments of a decision tree-based algorithm that take into account data center guidelines and attributes for network ports, clustering, and/or other features. In some cases, these embodiments may be integrated with other datacenter management software as extensions that enable a single solution for various datacenter activities.

### SUMMARY

Systems and methods for datacenter capacity planning are described. In an illustrative, non-limiting embodiment, an Information Handling System (IHS) may include a processor and a memory coupled to the processor, the memory having program instructions stored thereon that, upon execution, cause the IHS to: receive user input; and suggest a location for placement of a device in a selected rack of a datacenter based on the user input, where the suggested location takes into account at least one of: (a) device clustering, or (b) network port availability.

In some cases, the user input may include datacenter information and a device list. State of the datacenter information may include: new or pre-existing. Datacenter information may include: rack identification, power capacity of each rack, and network port availability of each rack. The device list may include at least one of: a device type, a device model, a number of devices, and a service tag. The device type may be selected from the group consisting of: a monolithic server, a modular server, a network device, a storage enclosure, and a cluster.

The user input further may include a placement approach selected from the group consisting of: greedy and round-robin. In some cases, the program instructions, upon execution, cause the IHS to retrieve a device specification file based upon a service tag obtained from the user input, where the device specification file include a physical size and a power specification of the device associated with the service tag.

To suggest the location, the program instructions, upon execution, may further cause the IHS to: sort a list of devices by weight or physical size, with the heaviest or largest device being at the bottom of the list, and the lightest or smallest device being at the top of the list; and select the rack based upon a comparison between the list of the devices and a slot availability of the rack. Additionally, or alternatively, to suggest the location, the program instructions, upon execution, may cause the IHS to sum the physical size or weight of two or more devices identified as part of a cluster and suggest the location for the cluster in a single rack. Additionally, or alternatively, to suggest the location, the program instructions, upon execution, may cause the IHS to: receive the network port availability from a Top-of-Rack (ToR) switch associated with the selected rack via a command-line (CLI) command; and verify that network port requirements of the device match the network port availability.

In another illustrative, non-limiting embodiment, a memory storage device may have program instructions stored thereon that, upon execution by a processor of an IHS, cause the IHS to: receive user input; and suggest a location for placement of a device in a selected rack of a datacenter based on the user input, where the suggested location takes into account device clustering.

In yet another illustrative, non-limiting embodiment, a method may include receiving user input at an IHS, where the user input comprises: rack identification, power capacity of each rack, a device type, a device model, a number of devices, and a service tag; retrieving, by the IHS, a device specification file based upon the service tag, wherein the device specification file comprises a physical size and a power specification of the device associated with the service tag; sorting, by the IHS, a list of devices by weight or physical size, with the heaviest or largest device at the bottom of the list, and the lightest or smallest device at the top of the list; selecting, by the IHS, the rack based upon a comparison between the list of the devices and a slot availability of the rack; and suggesting, by the IHS, a location for placement of a device in a selected rack of a datacenter based on the user input and the device specification file, where the suggested location takes into account network port availability.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 is a diagram illustrating example components of an Information Handling System (IHS) for use in a rack-mounted chassis, according to some embodiments.

FIG. 2 is an illustration of an example of a software system for datacenter capacity planning, according to some embodiments.

FIGS. 3A, 3B, 4-16, 17A, 17B, 18A, 18B, 19-21, 22A, 22B, and 23-26 are illustrations of examples of methods for datacenter capacity planning, according to some embodiments.

FIGS. 27 and 28 are illustrations of examples of IHS placement recommendations, according to some embodiments.

### DETAILED DESCRIPTION

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources, such as a Central Processing Unit (CPU) or hardware or software control logic, Read-Only Memory (ROM), and/or other types of nonvolatile memory.

Additional components of an IHS may include one or more disk drives, one or more network ports for communicating with external devices as well as various I/O devices, such as a keyboard, a mouse, touchscreen, and/or a video display. An IHS may also include one or more buses operable to transmit communications between the various hardware components. An example of an IHS is described in more detail below. It should be appreciated that although certain IHSs described herein may be discussed in the context of enterprise computing servers, other embodiments may be utilized.

As described, in a data center environment, an IHS may be installed within a chassis, in some cases along with other similar IHSs. A rack may house multiple such chassis and a data center may house numerous such racks. As such, each rack may host a large number of IHSs that are installed as components of a chassis and multiple chassis may be stacked and installed within racks.

In various embodiments, systems and methods described herein may provide IHS placement suggestions or recommendations in a selected rack and/or in a selected location within the given rack irrespective of the current state of the data center; that is, whether the IHS is being deployed in a brand new data center or within an existing data center with other IHS already placed.

Systems and methods described herein may use a decision tree-based approach that supports all IHS types such as servers (e.g., monolithic and modular), chassis (e.g., M1000e, FX2/FX2s, VRTX, MX7000), storage enclosures (e.g., rack and modular storage devices), and/or network devices (e.g., rack-level switches and chassis I/O modules), and clusters (e.g., a group of IHSs and other resources that act like a single system and enable high availability and, in some cases, load balancing and parallel processing).

In some cases, systems and methods described herein may consider parameters for rack space and network port availability along with user preferences (e.g., placement approach, Greedy or Round Robin) in case of a new data center. For an existing datacenter which is been monitored for a while in the appliance, metrics available for power and temperature may be considered in addition to the availability of rack space, network ports, and other user preferences. These systems and methods may also ensure that the placement suggestion is provided by displaying the heaviest devices towards the bottom of the rack and the lighter ones towards the upper rack slots. Devices entered as part of a cluster are maintained together.

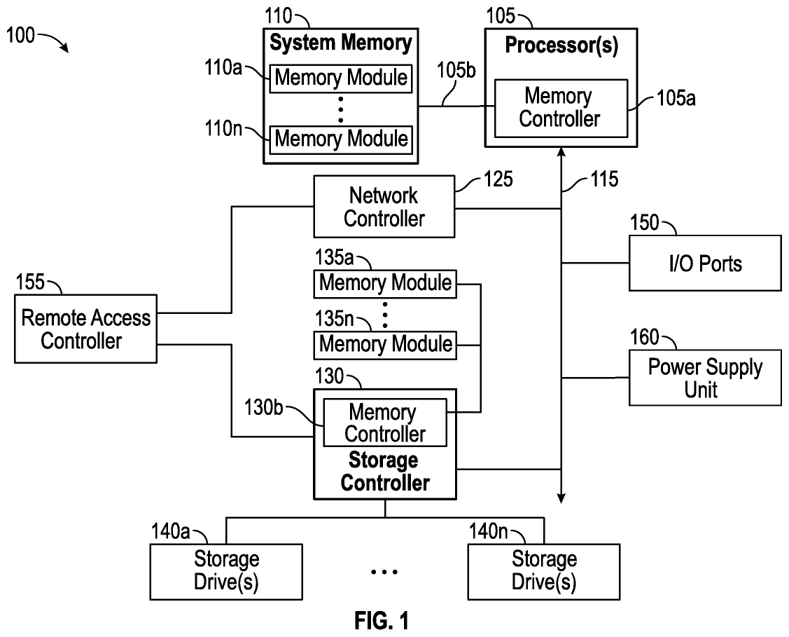

FIG. 1 illustrates example components of IHS 100 for use in a rack-mounted chassis having a flexible PSU bay. Although this example IHS 100 is described as a rack-mounted server, other implementations may use other types of IHSs. In this embodiment, IHS 100 may be a server installed within a chassis, which in turn is installed within one or more slots of a rack. In this manner, IHS 100 may utilize certain shared resources provided by the chassis and/or rack, such as power and networking. In some embodiments, multiple servers such as IHS 100 may be installed within a single chassis.

IHS 100 may include one or more processor(s) 105. In some embodiments, processor(s) 105 may include a main processor and a co-processor, each of which may include a plurality of processing cores. As illustrated, processor(s) 105 may include integrated memory controller 105a that may be implemented directly within the circuitry of processor(s) 105, or memory controller 105a may be a separate integrated circuit that is located on the same die as processor(s) 105. Memory controller 105a may be configured to manage the transfer of data to and from system memory 110 of IHS 100 via high-speed memory interface 105b.

System memory 110 may include memory components, such as such as static RAM (SRAM), dynamic RAM (DRAM), NAND Flash memory, suitable for supporting high-speed memory operations by processor(s) 105. System memory 110 may combine both persistent, non-volatile memory and volatile memory.

In certain embodiments, system memory 110 may include multiple removable memory modules. System memory 110 includes removable memory modules 110a-n. Each of removable memory modules 110a-n may utilize a form factor corresponding to a motherboard expansion card socket that receives a type of removable memory module 110a-n, such as a DIMM (Dual In-line Memory Module). Other embodiments of system memory 110 may be configured with memory socket interfaces that correspond to different types of removable memory module form factors, such as a Dual In-line Package (DIP) memory, a Single In-line Pin Package (SIPP) memory, a Single In-line Memory Module (SIMM), and/or a Ball Grid Array (BGA) memory.

IHS 100 may operate using a chipset that may be implemented by integrated circuits that couple processor(s) 105 to various other components of the motherboard of IHS 100. In some embodiments, all or portions of the chipset may be implemented directly within the integrated circuitry of an individual one of processor(s) 105. The chipset may provide the processor(s) 105 with access to a variety of resources accessible via one or more buses 115. Various embodiments may utilize any number of buses to provide the illustrated pathways provided by single bus 115. In certain embodiments, bus 115 may include a PCIe (PCI Express) switch fabric that is accessed via a root complex and coupled processor(s) 105 to a variety of internal and external PCIe devices.

In various embodiments, a variety of resources may be coupled to the processor(s) 105 of the IHS 100 via buses 115 managed by the processor chipset. In some cases, these resources may be components of the motherboard of IHS 100 or these resources may be resources coupled to IHS 100, such as via I/O ports 150. In some embodiments, IHS 100 may include one or more I/O ports 150, such as PCIe ports, that may be used to couple IHS 100 directly to other IHSs, storage resources or other peripheral components. In certain embodiments, I/O ports 150 may provide couplings to a backplane or midplane of the chassis in which the IHS 100 is installed. In some instances, I/O ports 150 may include rear-facing externally accessible connectors by which external systems and networks may be coupled to IHS 100.

As illustrated, IHS 100 may also include Power Supply Unit (PSU) 160 that provides the components of the chassis with appropriate levels of DC power. PSU 160 may receive power inputs from an AC power source or from a shared power system that is provided by a rack within which IHS 100 may be installed. In certain embodiments, PSU 160 may be implemented as a swappable component that may be used to provide IHS 100 with redundant, hot-swappable power supply capabilities.

Processor(s) 105 may also be coupled to network controller 125, such as provided by a Network Interface Controller (NIC) that is coupled to the IHS 100 and allows IHS 100 to communicate via an external network, such as the Internet or a LAN. Network controller 125 may include various microcontrollers, switches, adapters, and couplings used to connect IHS 100 to a network, where such connections may be established by IHS 100 directly or via shared networking components and connections provided by a rack in which chassis 100 is installed. In some embodiments, network controller 125 may allow IHS 100 to interface directly with network controllers from other nearby IHSs in support of clustered processing capabilities that utilize resources from multiple IHSs.

IHS 100 may include one or more storage controllers 130 that may be utilized to access storage drives 140a-n that are accessible via the chassis in which IHS 100 is installed. Storage controllers 130 may provide support for RAID (Redundant Array of Independent Disks) configurations of logical and physical storage drives 140a-n. In some embodiments, storage controller 155 may be an HBA (Host Bus Adapter) that provides limited capabilities in accessing physical storage drives 140a-n. In many embodiments, storage drives 140a-n may be replaceable, hot-swappable storage devices that are installed within bays provided by the chassis in which IHS 100 is installed. In some embodiments, storage drives 140a-n may also be accessed by other IHSs that are also installed within the same chassis as IHS 100. In various embodiments, storage drives 140a-n may include SAS (Serial Attached SCSI) magnetic disk drives, SATA (Serial Advanced Technology Attachment) magnetic disk drives, solid-state drives (SSDs) and other types of storage drives in various combinations.

As with processor(s) 105, storage controller 130 may also include integrated memory controller 130b that may be used to manage the transfer of data to and from one or more memory modules 135a-n via a high-speed memory interface. Through use of memory operations implemented by memory controller 130b and memory modules 135a-n, storage controller 130 may operate using cache memories in support of storage operations. Memory modules 135a-n may include memory components, such as such as static RAM (SRAM), dynamic RAM (DRAM), NAND Flash memory, suitable for supporting high-speed memory operations and may combine both persistent, non-volatile memory and volatile memory. As with system memory 110, memory modules 135a-n may utilize a form factor corresponding to a memory card socket, such as a DIMM (Dual In-line Memory Module).

IHS 100 includes a remote access controller (RAC) 155 that provides capabilities for remote monitoring and management of various aspects of the operation of IHS 100. In support of these monitoring and management functions, remote access controller 155 may utilize both in-band and sideband (i.e., out-of-band) communications with various internal components of IHS 100.

Remote access controller 155 may additionally implement a variety of management capabilities. In some instances, remote access controller 155 operate from a different power plane from processor(s) 105, storage drives 140a-n and other components of IHS 100, thus allowing remote access controller 155 to operate, and management tasks to proceed, while processor cores of IHS 100 are powered off. Various BIOS functions, including launching the operating system of IHS 100, may be implemented by remote access controller 155. In some embodiments, remote access controller 155 may perform various functions to verify the integrity of the IHS 100 and its hardware components prior to initialization of the IHS 100 (i.e., in a bare-metal state).

In various embodiments, an IHS may not include each of the components shown in FIG. 1. Additionally, or alternatively, an IHS may include various additional components in addition to those that are shown in FIG. 1. Furthermore, some components that are represented as separate components in FIG. 1 may in certain implementations be integrated with other components. For example, in certain embodiments, all or a portion of the functionality provided by the illustrated components may instead be provided by components integrated into one or more processor(s) 105 as a systems-on-a-chip.

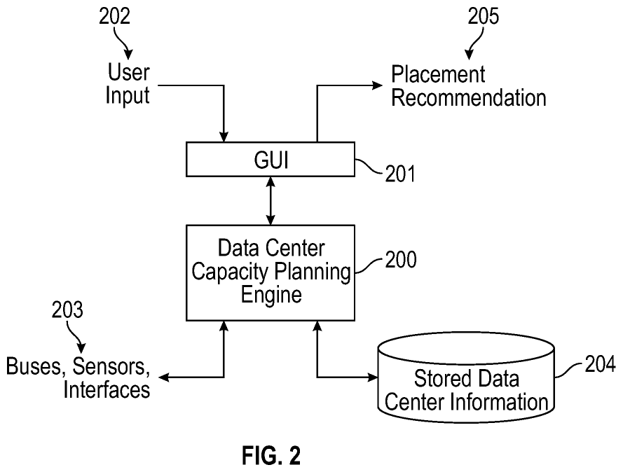

FIG. 2 is an illustration of an example of software system 200 for data center capacity planning. In some embodiments, software system 200 may be instantiated, at least in part, through the execution of program instructions stored in memory 110 by processor(s) 105. As shown, data center capacity planning engine 200 is in communication with buses, sensors, and/or interfaces 203, as well as stored information 204. Using Graphical User Interface (GUI) 201, data center capacity planning engine 200 may receive user input(s) 202 and provide placement recommendation(s) 205. Examples of these various features are described in more detail below.

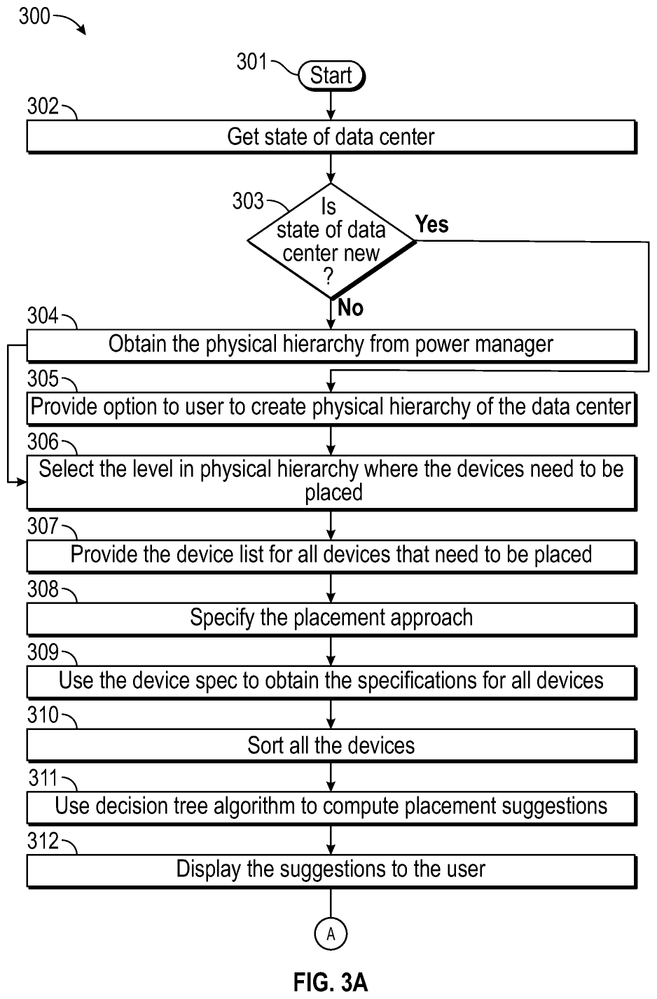

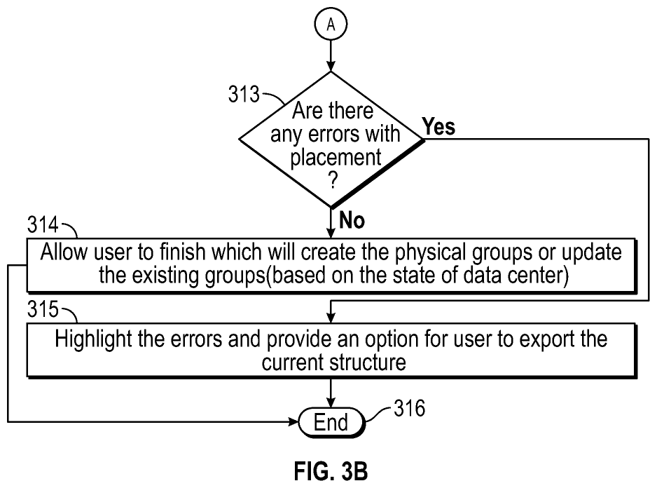

In operation, data center capacity planning engine 200 may execute one or more of the various methods shown in FIGS. 3A, 3B, 4-16, 17A, 17B, 18A, 18B, 19-21, 22A, 22B, and 23-26. Generally speaking, these operations comprise: (A) receiving user inputs, (B) processing information; and (C) providing a placement recommendation:

(A) User Inputs

User inputs may include information about the current data center hierarchy and/or a list of IHSs and/or devices to be considered for placement suggestions. Examples of inputs are a “State of Data Center” (e.g., a new data center or an existing data center) and “Data Center Hierarchy Details” (e.g., data center, room, aisle, and/or rack details).

In the case of an existing datacenter, in addition to an IHS/device list and placement approach, a user may add the existing schema of data center from a power manager software. If existing devices have been monitored by the power manager software, then metrics saved for power, temperature and space utilization may be referenced while providing placement recommendations. Conversely, for a new datacenter, user may provide rack size and power capacity for all available racks while entering the datacenter hierarchy details.

An IHS/device list may include a device type, model, and number of devices to be placed for each model. Examples of device types include, but are not limited to, monolithic servers, modular servers (including C-Series and M-Series servers), network devices, storage enclosures, and clusters. The term “cluster” refers to a group of servers/chassis functioning together or a group of servers along with storage enclosures and network devices attached. Device details including type, model and number of devices may be entered by the user for individual components of the defined cluster.

Additional inventory details may be referenced from stored IHS/device specification information. For example, an IHS/device specification file may be available (either online or offline) from which a number of device details such as device type, size (in Units U) and power specifications may be retrieved by querying a service tag.

Another user input may be a “placement approach,” which may be a “greedy” or “round robin” approach. The greedy approach considers IHS/device placement prioritizing the optimum utilization of available resources, such that it completes the placement on one rack completely before moving to the other one. The round robin approach suggests the best possible location for a device based on the resource availability across different hierarchical levels.

(B) Processing

The processing operation may utilize a decision tree algorithm along with user inputs for suggesting locations for IHS/device placement. All related inventory details (such as Power and Thermal specifications, U size, etc.) for the IHS/device models entered may be initially retrieved from the IHS/device specification file(s).

The algorithm may follow a sequential order with respect to the list of devices entered and identifies the number of devices. In the case of a single device or multiple devices entered, post device type retrieval, a sort operation may be applied on all devices so that the heaviest device (with maximum U size) are listed towards the bottom and the lightest device appears on the top of the list. In the case of clusters, a second, internal sorting operation may be applied so that the heaviest devices within the group are listed at the bottom of the cluster.

With respect to servers, the algorithm may identify the type of server and classify it either as modular or monolithic. Further details about the IHS/device required for providing placement suggestions (such as U size, device power capacity, etc.) may be retrieved from the IHS/device specification file(s). Modular servers may be mapped to their corresponding supported models of chassis and the server may be placed based on the placement approach and space availability. In addition to the above parameters, power and network port availability in the switches are taken into consideration.

Rack and chassis power capacity may be provided by the user as part of data center hierarchy details. For an existing datacenter hierarchy which is monitored for a while, the temperature may also be considered as a metric for providing placement suggestions.

The algorithm may retrieve the network port availability for Top-of-Rack (ToR) switches or IOM's via command-line (CLI) commands or from parent chassis inventory. In the case of monolithic servers, the placement approach and space availability may be taken into prior consideration. Thereafter, the device is placed based on power, thermal and network port availability in the selected rack. The internal sorting mechanism ensures that the heaviest device is placed at the lowest rack slots whereas the lightest device appears at the top.

As to chassis the algorithm identifies the type (model) of chassis and a similar placement approach is followed for PowerEdge MX7000 and M1000e models. Because MX7000 and M1000e stands among the heaviest devices, the algorithm first checks if there is available space (−10U) from the lowest rack slots. If so, the placement suggestion for MX7000 and M1000e is provided by considering the rack space capacity, power capacity, peak temperature values (for racks which are monitored for a while in an existing datacenter) and network port availability. For other chassis models such as FX2, FX2s, and VRTX, the placement logic is similar to that of monolithic servers.

In the case of clusters, the devices entered as part of the cluster list may be sorted internally with respect to device size. The sum of all individual device sizes is taken as the cluster size. As mentioned in the decision tree, placement suggestions are provided for clusters based on individual IHS placement suggestions, space capacity, power capacity, thermal values, and network port availability in the rack. In some implementations, valid placement suggestions may result only if there is space available in the same rack for placing all devices as part of the cluster. If not, the algorithm may exit with error messages by providing corrective actions to the user.

When dealing with storage and network devices, the algorithm may identify if the storage/network type is rack-based or chassis-based. In case of rack devices, the algorithm may consider the placement approach selected by the user. Thereafter, placement suggestions may be provided with respect to the analysis done for space capacity, power capacity, thermal values, and network port availability.

For chassis storage and network devices, the corresponding chassis type may be mapped and the logic may verify if the supported chassis type is entered as a part of the device list. If so, the most apt chassis slot may be identified based on placement suggestions, power and thermal metrics, and space capacity.

When there are no error conditions encountered by the algorithm, the recommendation may be provided for IHS/device placements in the hierarchical levels selected by the user. Also, there may be be a one-click option that replicates the device placement suggestions in the physical group section of power manager software. When an error is encountered by the algorithm, however, the hierarchy may be displayed excluding the devices which are in error state. Meanwhile, appropriate errors may be displayed and the one-click option to replicate physical groups may not be provided as the IHS/devices in error state needs to be accommodated.

(C) Recommendations and Suggestions

IHS/device placement recommendations and suggestions may be displayed via GUI 201 based upon user preferences and the logic defined as per the decision tree algorithm.

FIGS. 3A, 3B, 4-16, 17A, 17B, 18A, 18B, 19-21, 22A, 22B, and 23-26 are illustrations of examples of method(s) 300 for datacenter capacity planning. In some embodiments, these various methods may be performed in response to the execution of software system 200. Particularly, in FIGS. 3A and 3B, method 300 begins at block 301. At block 302, method 300 gets the state of the data center. At block 303, method 300 determines if the state of the data center is new. If so, block 305 provides an option to the user to create a physical hierarchy of the data center. Otherwise, block 304 obtains the physical hierarchy from the power management software.

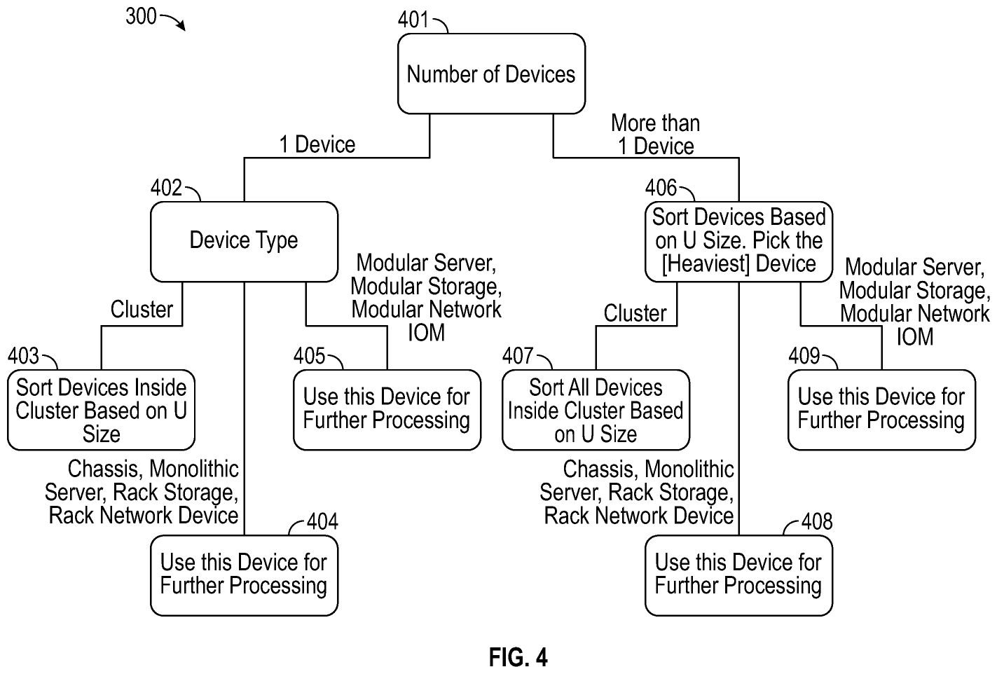

At block 306, method 300 may select a level in the physical hierarchy where IHS/devices need to be placed. At block 307, method 300 provides an IHS/device list for all devices that need to be placed. Then, at block 308, method 300 specifies the placement approach. Block 309 uses device specification files to obtain specifications for all devices, and block 310 sorts all the devices. Block 311 uses a decision tree algorithm to compute placement suggestions, as described in FIGS. 4-16, 17A, 17B, 18A, 18B, 19-21, 22A, 22B, and 23-26.

Block 312 displays suggestions to the user. At block 313, method 300 determines if there are any errors with placement. If not, block 314 allows the user to finish the placement process which creates physical groups and/or updates existing groups depending upon the state of the data center. If so, block 315 highlights errors and provides an option for the user to save or export the current structure. Method 300 ends at block 316.

In FIG. 4, at block 401 and in connection with receiving a device list at block 307, method 300 determines a number of devices to be placed. If a single device is being placed, block 402 identifies a device type. If the device type is a cluster, block 403 sorts devices inside the cluster based on U-size. If the device type is a chassis, monolithic server, rack storage, or rack network device, the device is used for further processing at block 404. If the device type is a modular server, modular storage, or modular network IOM, block 405 uses that device for further processing.

If block 401 determines that more than one device is being placed in the data center, block 406 sorts devices based on U size, and picks the heaviest and/or largest device. If one of the devices is a cluster, block 407 sorts devices inside the cluster based on U-size. If the one of the devices is a chassis, monolithic server, rack storage, or rack network device, the device is used for further processing at block 408. If one of the devices is a modular server, modular storage, or modular network IOM, block 409 uses that device for further processing.

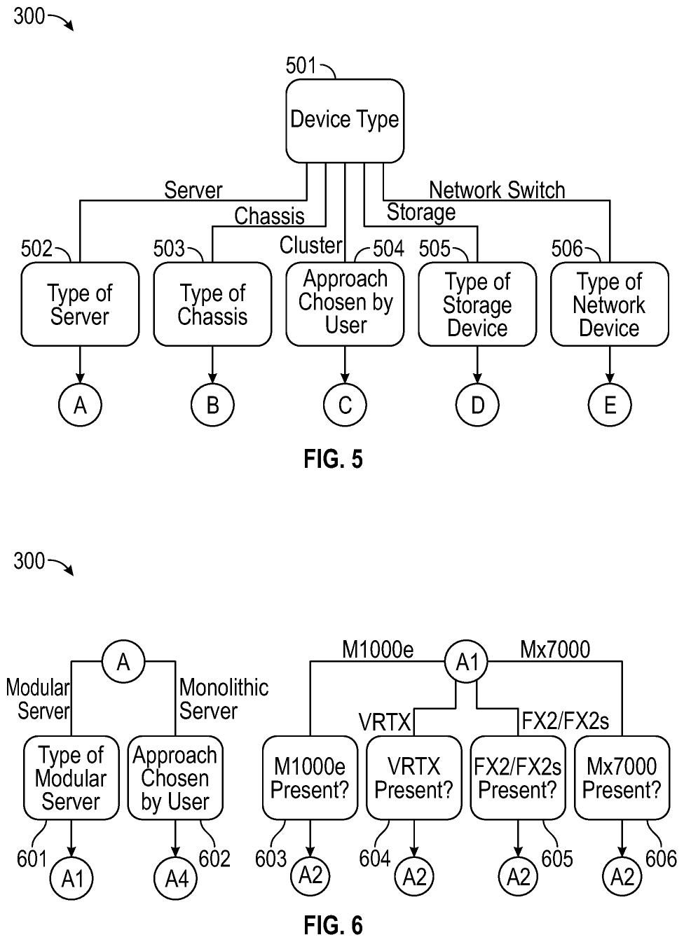

In FIG. 5, at block 501 and in connection with block 310, method 300 identifies a device type. If the device type is a server, block 502 identifies the type of server and control passes to node A. If the device type if a chassis, block 503 identifies the type of chassis and control passes to node B. If the device type if a cluster, block 504 identifies the cluster based upon the approach selected by the user, and control passes to node C. If the device type if storage, block 505 identifies the type of storage device and control passes to node D. If the device type if a network switch, block 506 identifies the type of network device and control passes to node E.

In FIG. 6, node A further classifies the server as a modular server, block 601 identifies the type of modular service and control passes to node A1. If node A further classifies the server as a monolithic server, block 602 identifies the server according to an approach selected by the user and control passes to node A4. From node A1, block 603 determines if an M1000e modular server is present, block 604 determines if a VRTX modular server is present, block 605 determines if an FX2/FX2s modular server is present, and block 606 determines if an MX7000 server is present. Then, control passes to node A2.

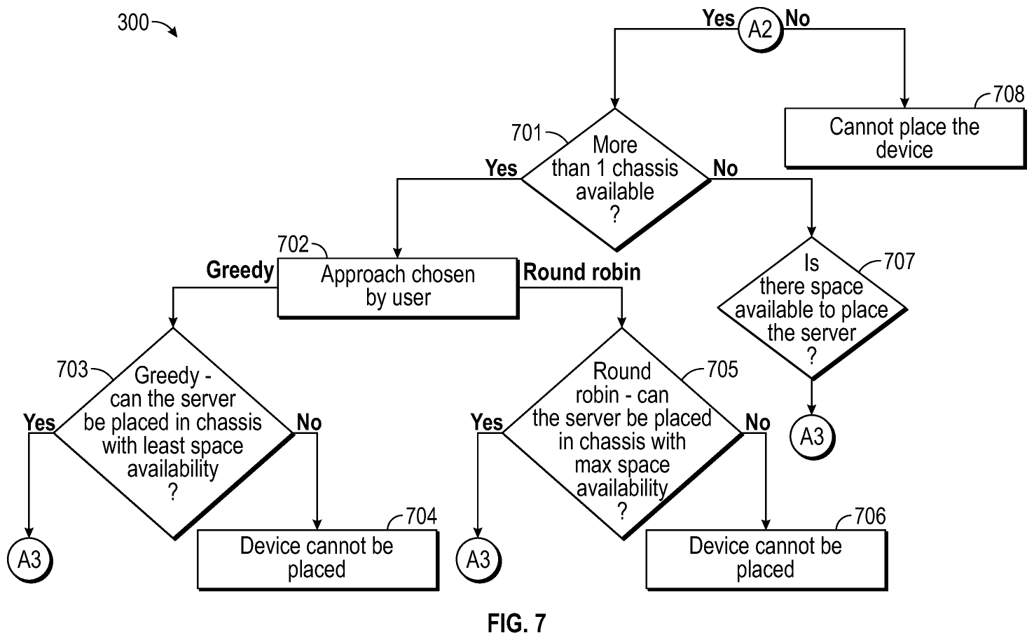

In FIG. 7, node A2 determines whether there are any chassis available in the data center. If not, block 708 determines that method 300 cannot place the device. Otherwise block 701 determines whether there is more than one chassis available. If not, block 707 determines if there is space available to place the server, and control passes to node A3. If so, block 702 identifies the placement approach selected by the user.

If the placement approach is the greedy approach, block 703 determines if the server can be placed in the chassis with the least space availability. If not, block 704 determines that the device cannot be placed. If so, control passes to block A3. Conversely, if the placement approach is the round robin approach, block 705 determines if the server can be placed in the chassis with the most or maximum space availability. If not, block 706 determines that the device cannot be placed. If so, control passes to block A3.

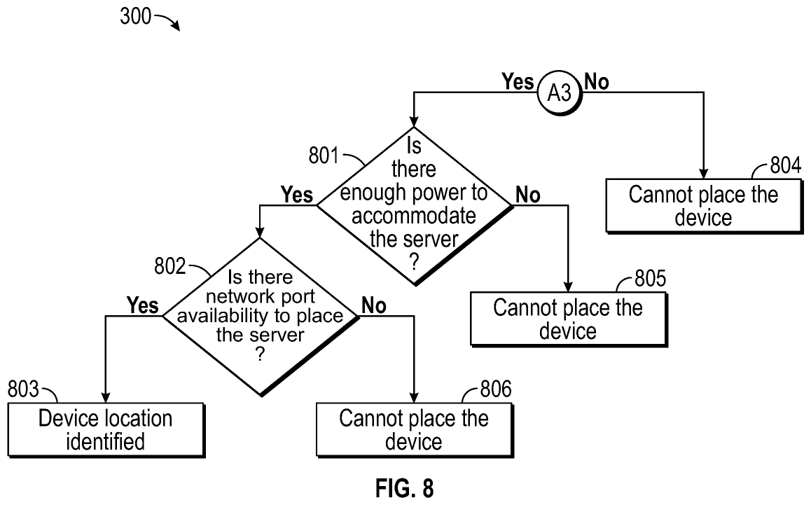

In FIG. 8, the answer to block 707 is no, block 804 determines that method 300 cannot place the device. Otherwise, at block 801, method 300 determines if there is enough power to accommodate the server. If not, block 805 determines that method 300 cannot place the device. If so, block 802 determines if there is network port availability to place the server. If not, block 806 determines that method 300 cannot place the device. If so, block 803 identifies the device's location in the data center.

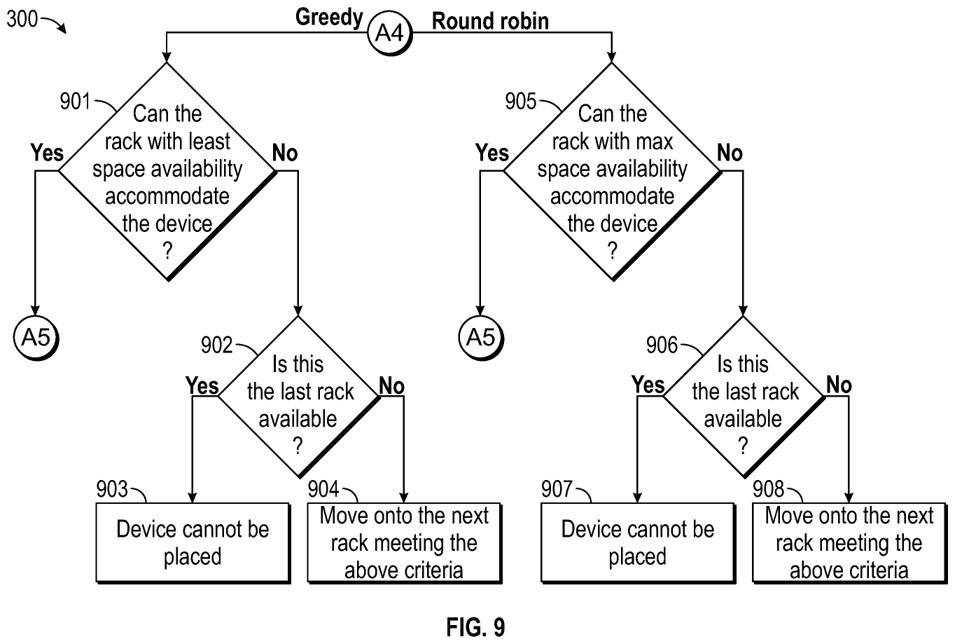

In FIG. 9, if the user selected the greedy approach at node A4, block 901 determines whether the rack with least space availability accommodate the device. If so, control passes to node A5. If not, block 902 determines if this is the last rack available. If so, block 903 determines that the device cannot be placed. Otherwise, block 904 moves onto the next rack meeting the aforementioned criteria.

Conversely, if the user selected the round robin approach at node A4, block 905 determines whether the rack with most or maximum space availability can accommodate the device. If so, control passes to node A5. If not, block 906 determines if this is the last rack available. If so, block 907 determines that the device cannot be placed. Otherwise, block 908 moves onto the next rack meeting the aforementioned criteria.

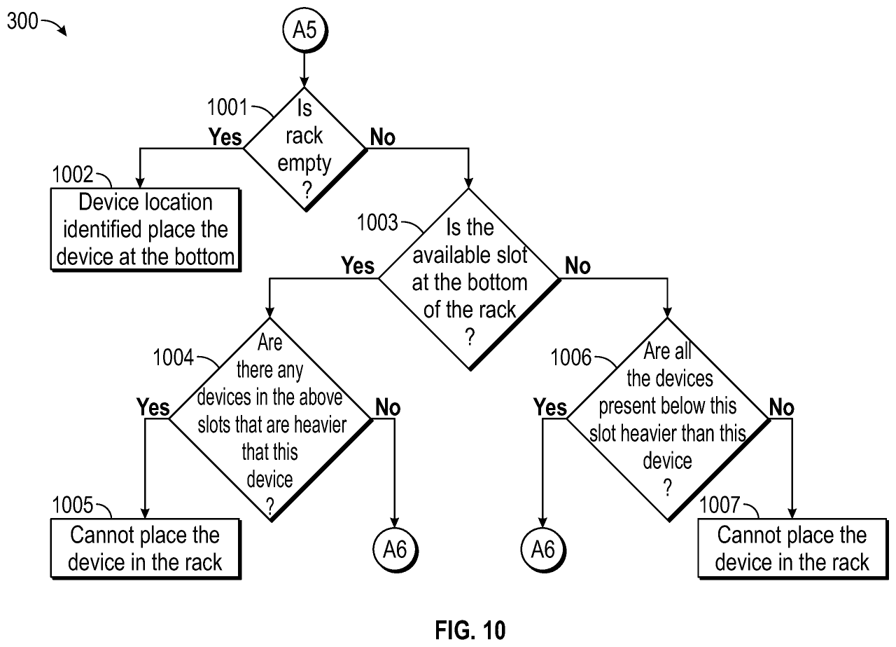

In FIG. 10, from node A5, block 1001 determines if the rack is empty. If so, the device location is identified in block 1002 and placed at the bottom of the rack. If not, block 1003 determines if there is an available slot at the bottom of the rack. If so, block 1004 determines if there are any devices in the above slots that are heavier than the current device under consideration. If so, block 1005 determines that the device cannot be placed in the rack. Otherwise control passes to node A6.

If block 1003 determines that there is no available slot at the bottom of the rack, block 1006 determines if all devices present below the slot are heavier than the currently device under consideration. If so, control passes to block A6. If not, block 1007 determines that the device cannot be placed in the rack.

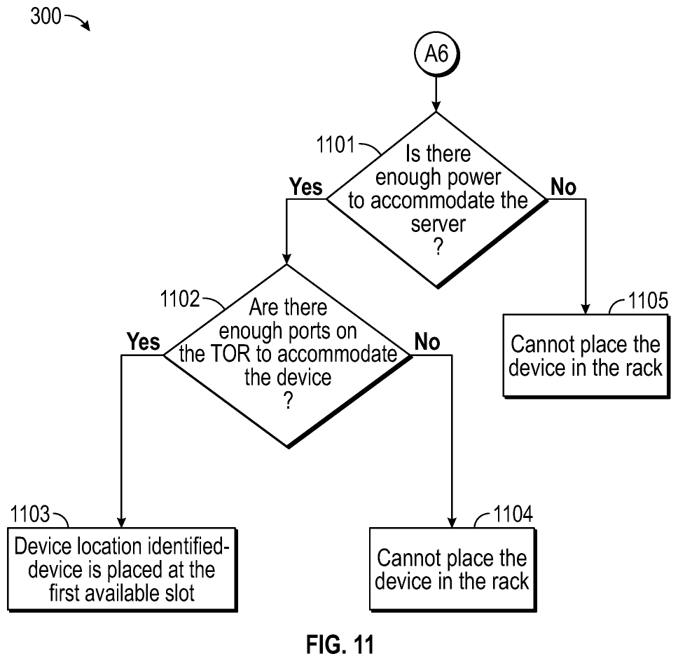

In FIG. 11, from node A6, block 1101 determines if there is enough power to accommodate the server. If not, block 1105 determines that the device cannot be placed in the rack. If so, block 1102 determines if there are enough ports in the TOR to accommodate the device. If so, block 1103 identifies the device location and it is placed at the first available slot. Otherwise, block 1104 determines that the device cannot be placed in the rack.

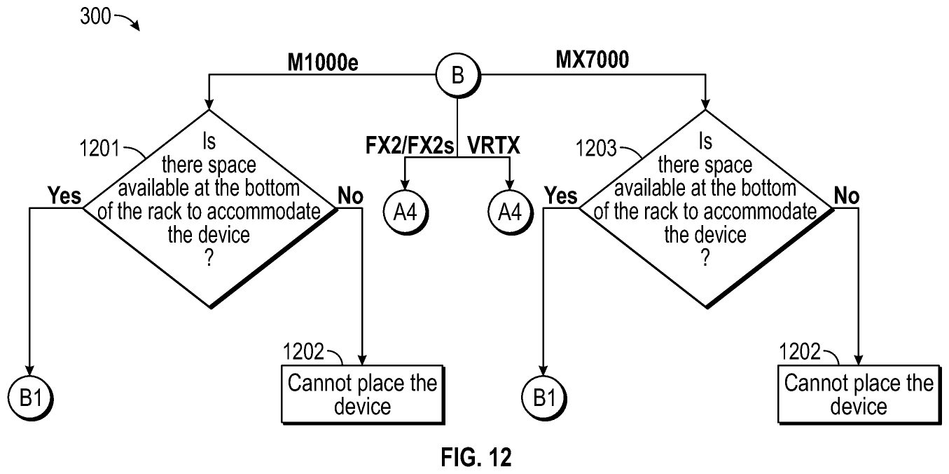

FIG. 12 starts from node B of FIG. 5. If the chassis type is M1000e, for example, block 1201 determines if there is space available at the bottom of the rack to accommodate the device. If so, control passes to node B1. If not, block 1202 determines that the device cannot be placed. If the chassis type is FX2/FX2s or VRTX, control passes to node A4. If the device is a MX7000 chassis, block 1203 determines if there is space available at the bottom of the rack to accommodate the device. If so, control passes to node B1. If not, block 1204 determines that the device cannot be placed.

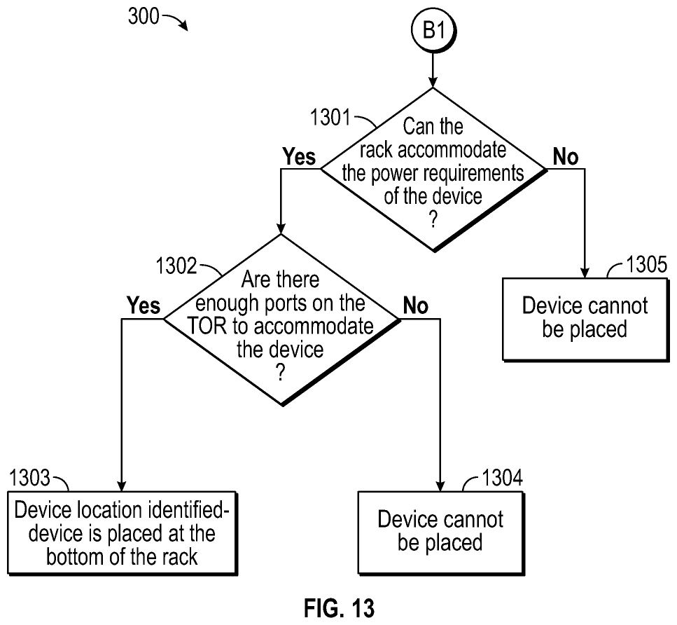

In FIG. 13, node B1 passes control to block 1301, where method 300 determines if the rack can accommodate the power requirements of the device. If not, block 1305 determines that the device cannot be placed. If so, block 1302 determines if there are enough ports on the TOR to accommodate the device. If not, block 1304 determines that the device cannot be placed. If so, block 1303 identifies a location for the device placed at the bottom of the selected rack.

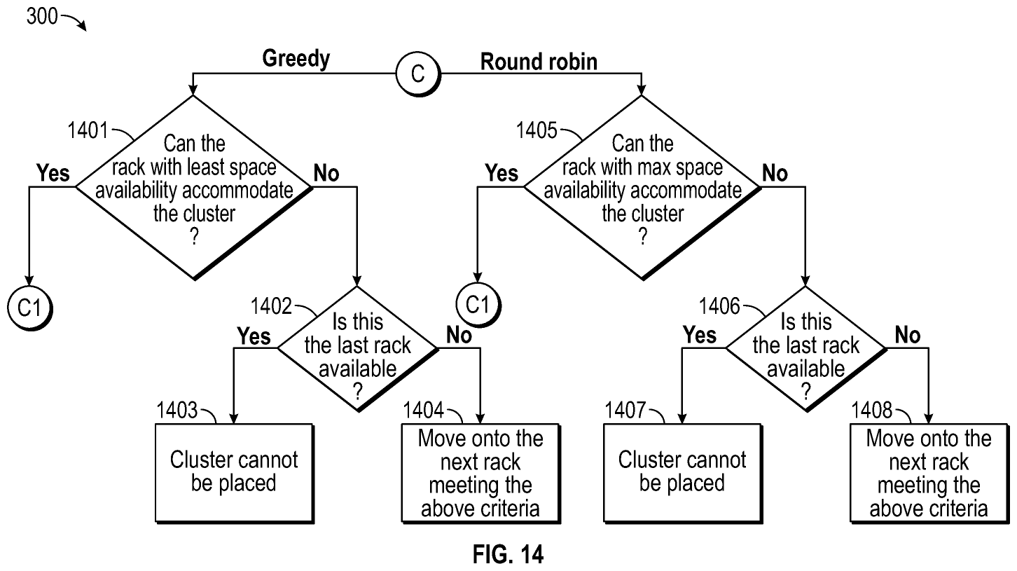

In FIG. 14, if the approach selected by user in block 504 of FIG. 5 is the greedy approach, block 1401 determines if the rack with the least space availability can accommodate the cluster. If so, control passes to node C1. Otherwise, block 1402 determines if this is the last rack available. If so, block 1403 determines that the cluster cannot be placed. Otherwise, at block 1404, method 300 moves to the next rack meeting the aforementioned criteria.

Conversely, if the approach selected by user in block 504 of FIG. 5 is the round robin approach, block 1405 determines if the rack with the most or maximum space availability can accommodate the cluster. If so, control passes to node C1. Otherwise, block 1406 determines if this is the last rack available. If so, block 1407 determines that the cluster cannot be placed. Otherwise, at block 1408, method 300 moves to the next rack meeting the aforementioned criteria.

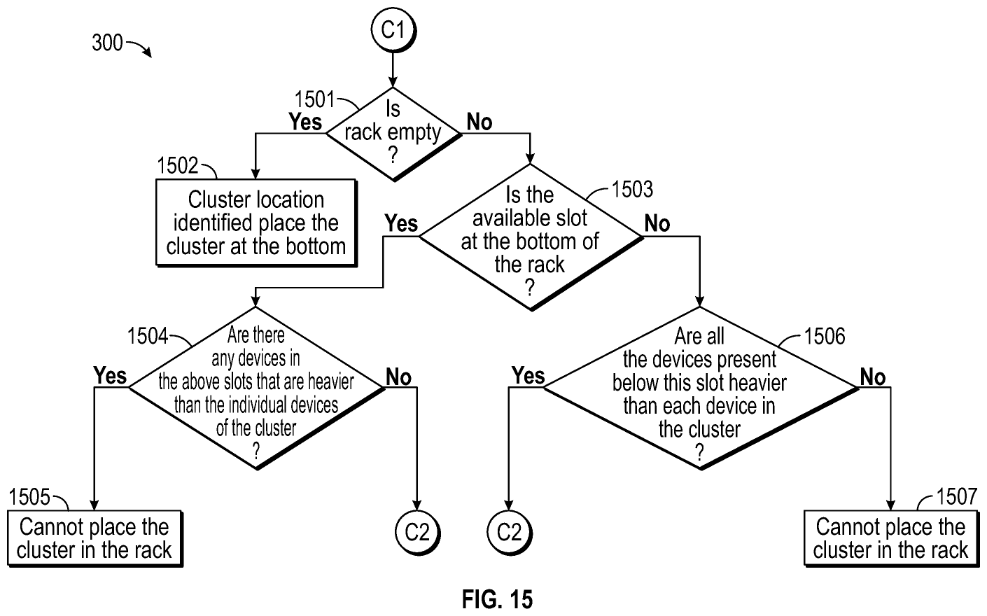

In FIG. 15, node C1 passes control to block 1502, where method 300 determines if the rack is empty. If so, block 1502 identifies a cluster location and places the cluster at the bottom. If not, block 1503 determines if the available slot is at the bottom of the rack. If so, block 1504 determines if there are any devices in the slots above that are heavier than the individual devices in the cluster. If so, block 1505 determines that the cluster cannot be placed. If not, control passes to node C2.

If block 1503 determines that the available slot is not at the bottom of the rack, block 1506 determines if all devices present below the current slot are heavier than each device in the cluster. If not, block 1507 determines that the cluster cannot be placed. If so, control passes to node C2.

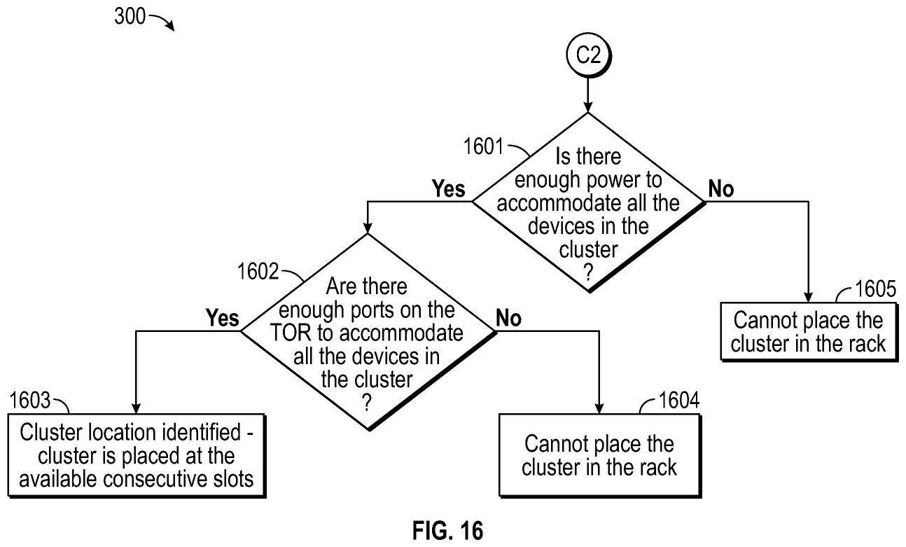

In FIG. 16, node C2 passes control to block 1601, where method 300 determines if there is enough power to accommodate all the devices in the cluster. If not, block 1507 determines that the cluster cannot be placed in the rack. If so, block 1602 determines if there are enough ports on the TOR to accommodate all devices in the cluster. If not, block 1604 determines that the cluster cannot be placed. If so, block 1603 identifies the cluster location and the cluster is placed at available consecutive slots.

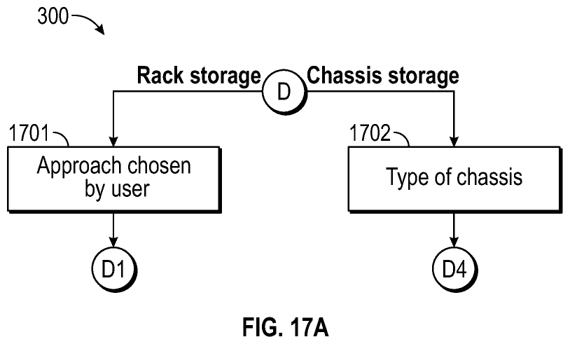

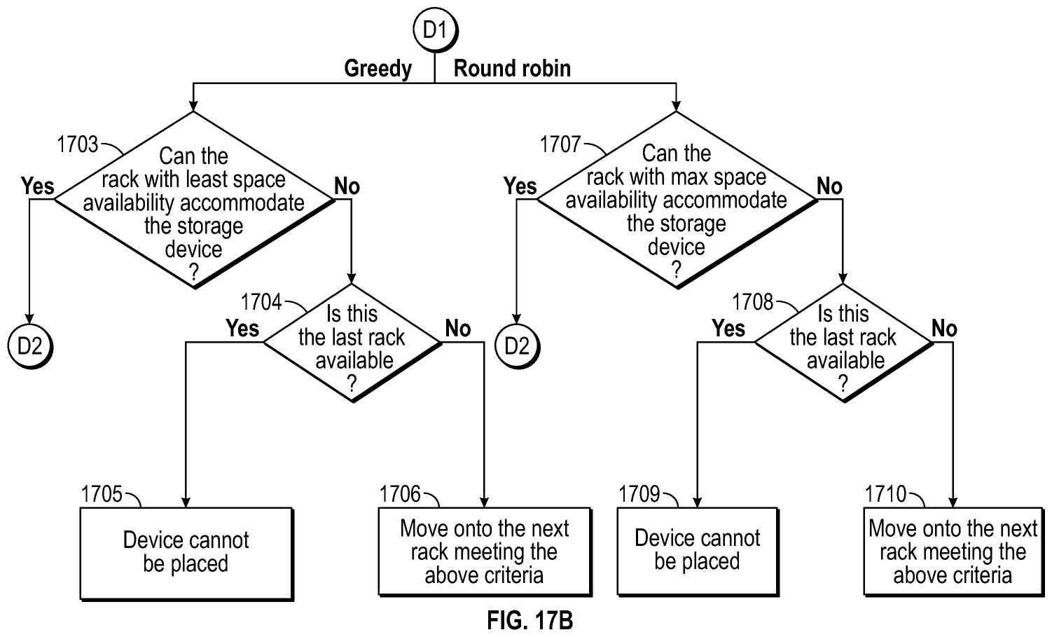

FIGS. 17A and 17B start from node D of FIG. 5. If the storage device type is rack storage, for example, block 1701 determines the placement approach selected by the user and control passes to block D1. If the storage device type is chassis storage, block 1702 determines the type of chassis and control passes to node D4.

From node D1, if the greedy approach is selected, block 1703 determines if the rack with least space availability can accommodate the storage device. If so, control passes to node D2. If not, block 1704 determines if this is the last rack available. If so, block 1705 determines that the device cannot be placed. Otherwise, block 1706 moves onto the next rack meeting the aforementioned criteria.

Conversely, if the round robin approach is selected, block 1707 determines if the rack with most or maximum space availability can accommodate the storage device. If so, control passes to node D2. If not, block 1708 determines if this is the last rack available. If so, block 1709 determines that the device cannot be placed. Otherwise, block 1710 moves onto the next rack meeting the aforementioned criteria.

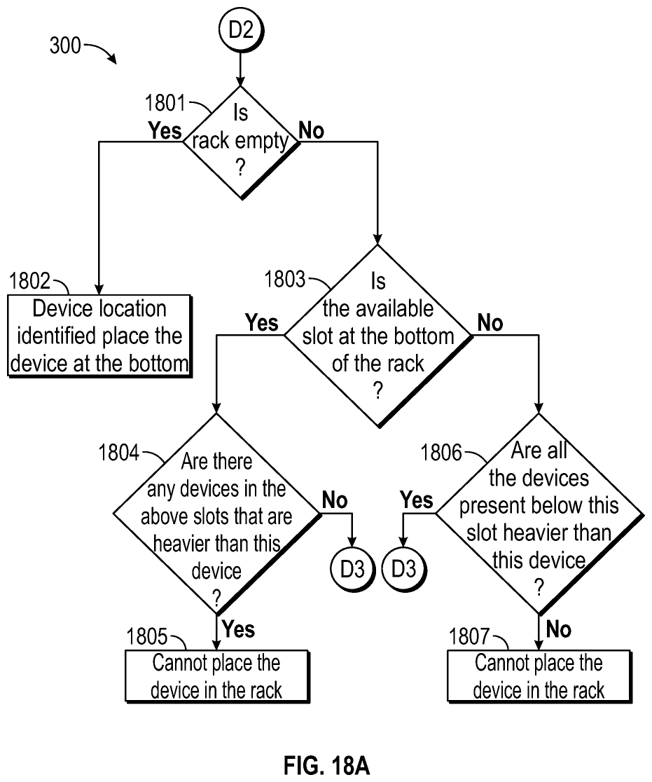

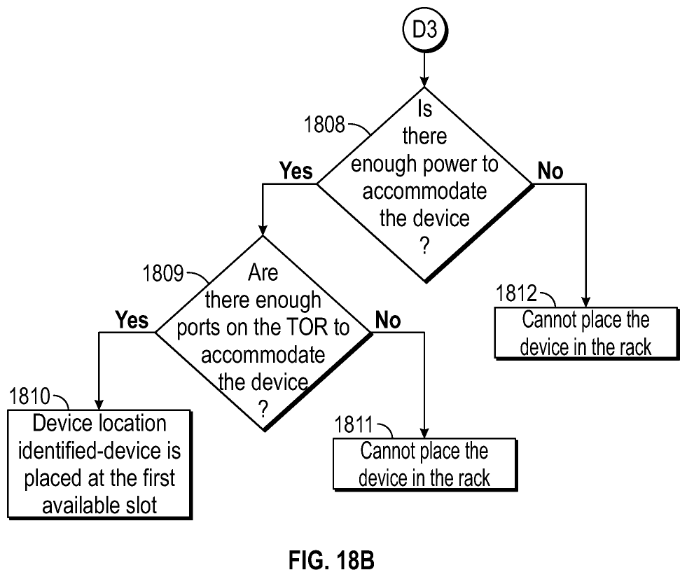

In FIGS. 18A and 18B, node D2 continues into block 1801 where method 300 determines if the rack is empty. If so, block 1802 identifies a device location and places the device at the bottom. If not, block 1803 determines if the available slot is at the bottom of the rack. If so, block 1804 determines if there are any devices in the slots above that are heavier than the device to be placed. If so, block 1505 determines that the device cannot be placed. If not, control passes to node D3.

If block 1803 determines that the available slot is not at the bottom of the rack, block 1506 determines if all devices present below the current slot are heavier than the device to be placed. If not, block 1807 determines that the device cannot be placed. If so, control passes to node D3.

Node D3 passes control to block 1808, where method 300 determines if there is enough power to accommodate all the devices in the cluster. If not, block 1812 determines that the cluster cannot be placed in the rack. If so, block 1809 determines if there are enough ports on the TOR to accommodate the device to be placed. If not, block 1811 determines that the device cannot be placed. If so, block 1810 identifies the device location and the device is placed at the first available slot.

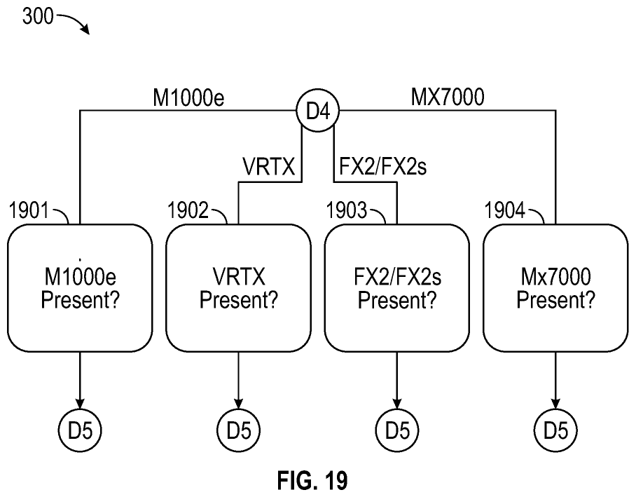

In FIG. 19, block 1901 receives node D4 and determines if an M1000e device is present, block 1902 determines if a VRTX device is present, block 1903 determines if an FX2/FX2s device is present, and block 1904 determines if an MX7000 device is present, before control passes to block D5.

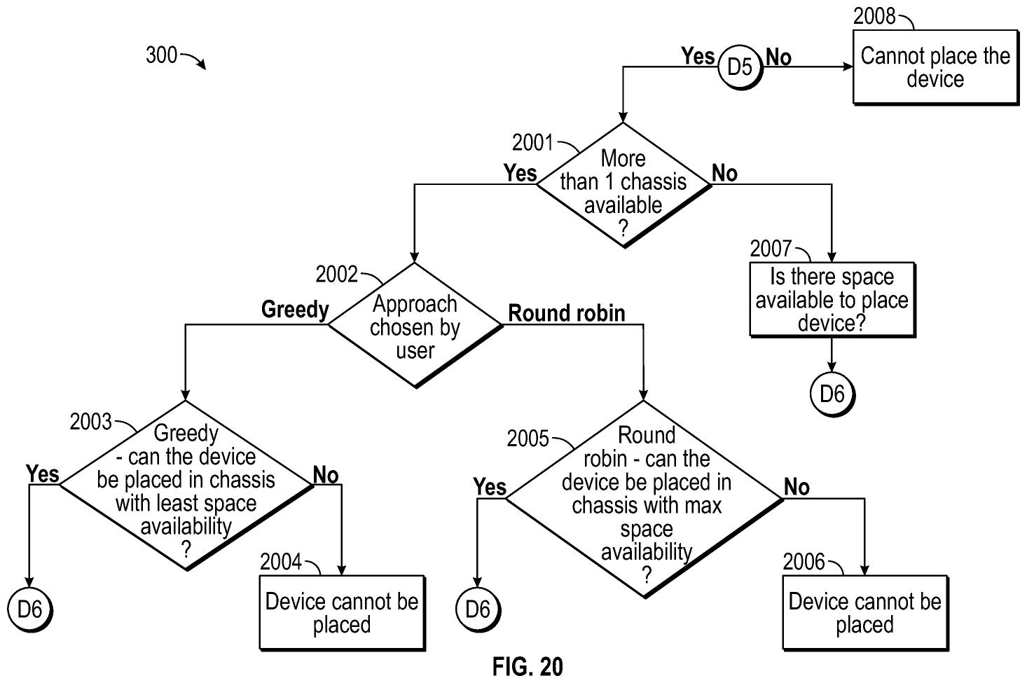

In FIG. 20, if the output of blocks 1901-1904 are no, block 2008 determines that it cannot place the device. Otherwise block 2001 determines whether there is more than one chassis available. If not, block 2007 determines if there is space available to place the device, and control passes to node D6. If so, block 2002 identifies the placement approach selected by the user.

If the placement approach is the greedy approach, block 2003 determines if the device can be placed in the chassis with the least space availability. If not, block 2004 determines that the device cannot be placed. If so, control passes to block D6. Conversely, if the placement approach is the round robin approach, block 2005 determines if the device can be placed in the chassis with the most or maximum space availability. If not, block 2006 determines that the device cannot be placed. If so, control passes to block D6.

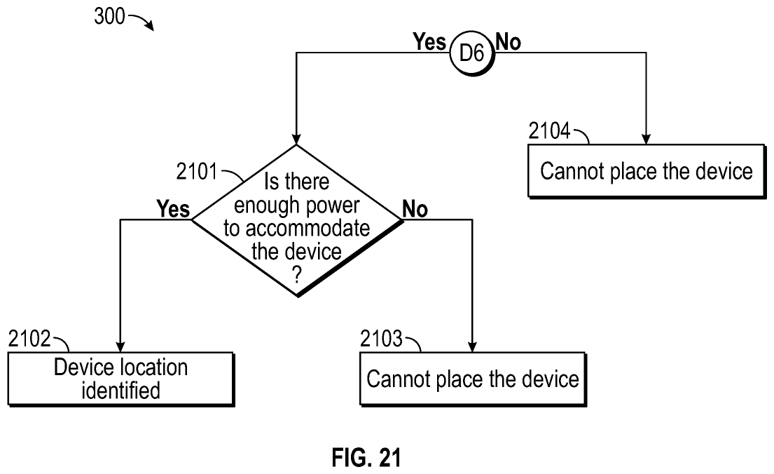

In FIG. 21, from node D6, if there is no space available, block 2104 determines that the device cannot be placed in the rack. If so, block 2101 determines if there is enough power to accommodate the device. If so, block 2102 identifies the device location. Otherwise, block 2103 determines that the device cannot be placed.

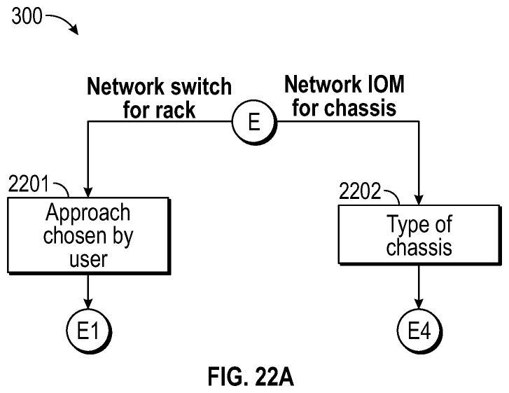

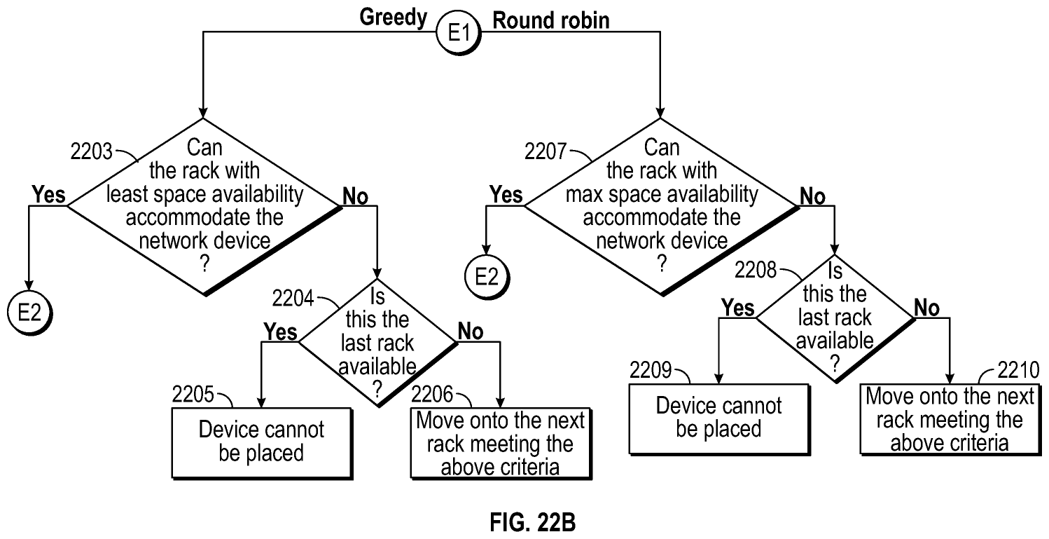

FIGS. 22A and 22B start from node E of FIG. 5. If the network device type is a network switch for a rack, for example, block 2201 determines the placement approach selected by the user and control passes to block E1. If the storage device type is a network IOM for chassis, block 2202 determines the type of chassis and control passes to node E4.

From node E1, if the greedy approach is selected, block 2203 determines if the rack with least space availability can accommodate the network device. If so, control passes to node E2. If not, block 2204 determines if this is the last rack available. If so, block 2205 determines that the device cannot be placed. Otherwise, block 2206 moves onto the next rack meeting the aforementioned criteria.

Conversely, if the round robin approach is selected, block 2207 determines if the rack with most or maximum space availability can accommodate the storage device. If so, control passes to node E2. If not, block 2208 determines if this is the last rack available. If so, block 2209 determines that the device cannot be placed. Otherwise, block 2210 moves onto the next rack meeting the aforementioned criteria.

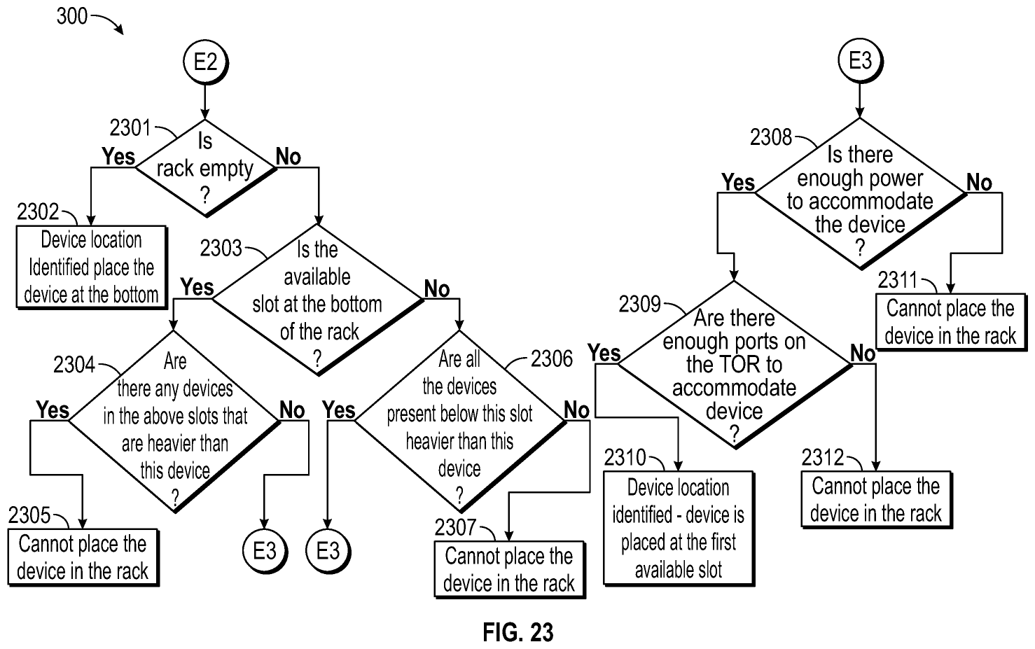

In FIG. 23, node E2 continues into block 2301 where method 300 determines if the rack is empty. If so, block 2302 identifies a device location and places the device at the bottom. If not, block 2303 determines if the available slot is at the bottom of the rack. If so, block 2304 determines if there are any devices in the slots above that are heavier than the device to be placed. If so, block 2305 determines that the device cannot be placed. If not, control passes to node E3.

If block 2303 determines that the available slot is not at the bottom of the rack, block 2306 determines if all devices present below the current slot are heavier than the device to be placed. If not, block 2307 determines that the device cannot be placed. If so, control passes to node E6.

Node E6 passes control to block 2308, where method 300 determines if there is enough power to accommodate the device. If not, block 2311 determines that the device cannot be placed in the rack. If so, block 2309 determines if there are enough ports on the TOR to accommodate the device to be placed. If not, block 2312 determines that the device cannot be placed. If so, block 2310 identifies the device location and the device is placed at the first available slot.

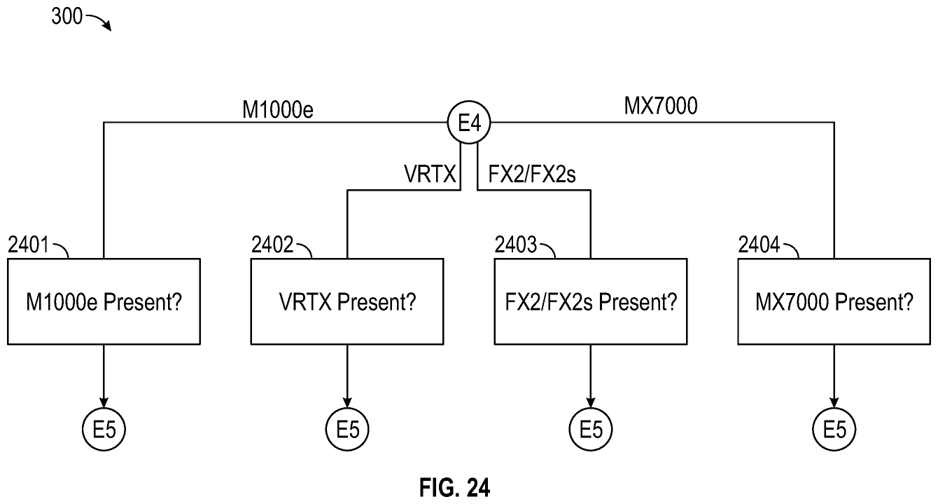

In FIG. 24, block 2401 receives node E4 and determines if an M1000e device is present, block 2402 determines if a VRTX device is present, block 2403 determines if an FX2/FX2s device is present, and block 2404 determines if an MX7000 device is present, before control passes to block E5.

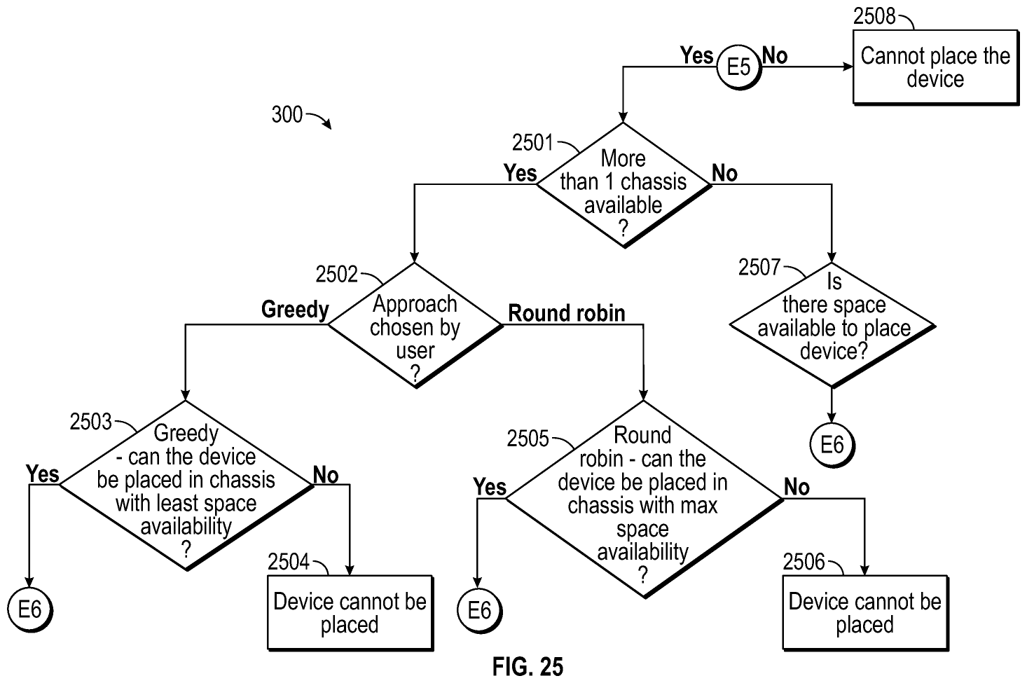

In FIG. 25, if the output of blocks 2401-2404 are no, block 2508 determines that it cannot place the device. Otherwise block 2501 determines whether there is more than one chassis available. If not, block 2507 determines if there is space available to place the device, and control passes to node E6. If so, block 2502 identifies the placement approach selected by the user.

If the placement approach is the greedy approach, block 2503 determines if the device can be placed in the chassis with the least space availability. If not, block 2504 determines that the device cannot be placed. If so, control passes to block E6.

Conversely, if the placement approach is the round robin approach, block 2505 determines if the device can be placed in the chassis with the most or maximum space availability. If not, block 2506 determines that the device cannot be placed. If so, control passes to block E6.

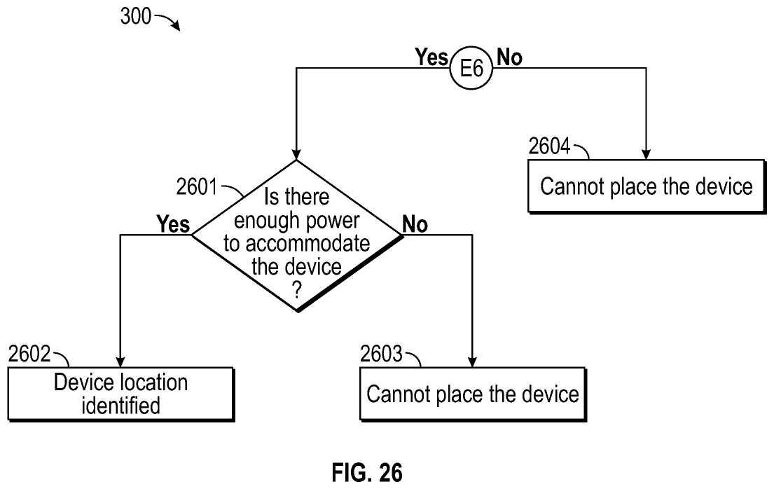

In FIG. 26, from node E6, if there is no space available, block 2604 determines that the device cannot be placed in the rack. If so, block 2601 determines if there is enough power to accommodate the device. If so, block 2602 identifies the device location. Otherwise, block 2603 determines that the device cannot be placed.

In case of a new data center, method 300 assumes that a TOR switch is already be configured in the rack and we can proceed with device placements. In the case of a new rack without any TOR switches configured, method 300 may be modified as follows:

First, method 300 queries the user about the state of the data center, the placement approach and the list of devices. Then, method 300 check if network switches are available in the list of devices purchased and entered as part of devices to be placed in a rack. If network switches are available in the list, method 300 can start with placing network switches across the racks based on the placement approach selected and then proceed with device placements (network port related information may be retrieved from the device specification sheet and the available network ports may be mapped to individual servers as per requirement). Method 300 is updated only for the placement of network switches whereas device placement logic can be maintained as the same.

In case of an existing datacenter, method 300 may check if the existing network ports of already configured switches is sufficient or not. If not, the new switches in the input list may be distributed across the racks and method 300 may proceed with device placement logic. In various implementations, method 300 may be purely automated so that an administrator does not have to spend time in analyzing where and how the device needs to be placed in the datacenter.

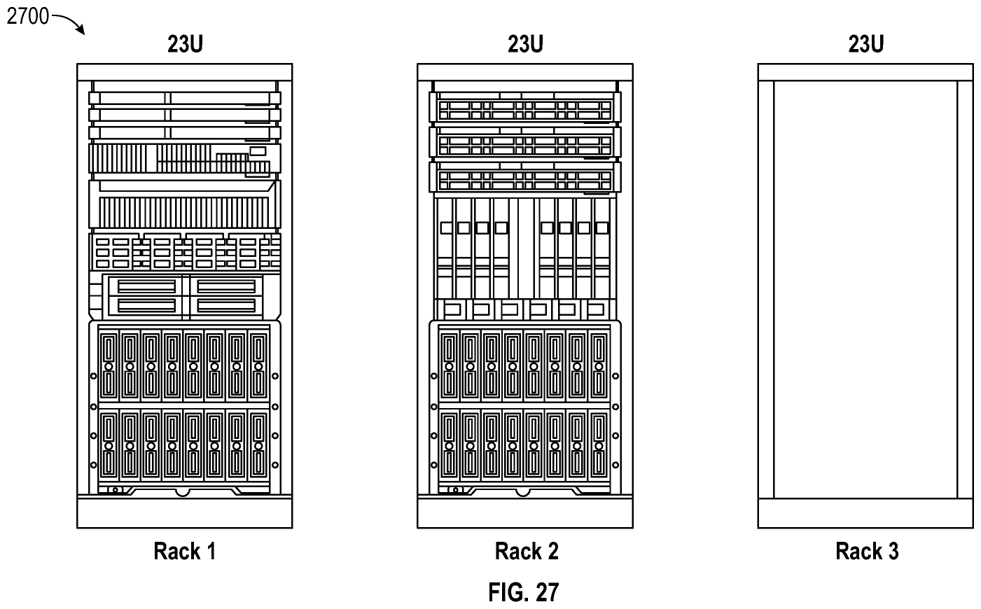

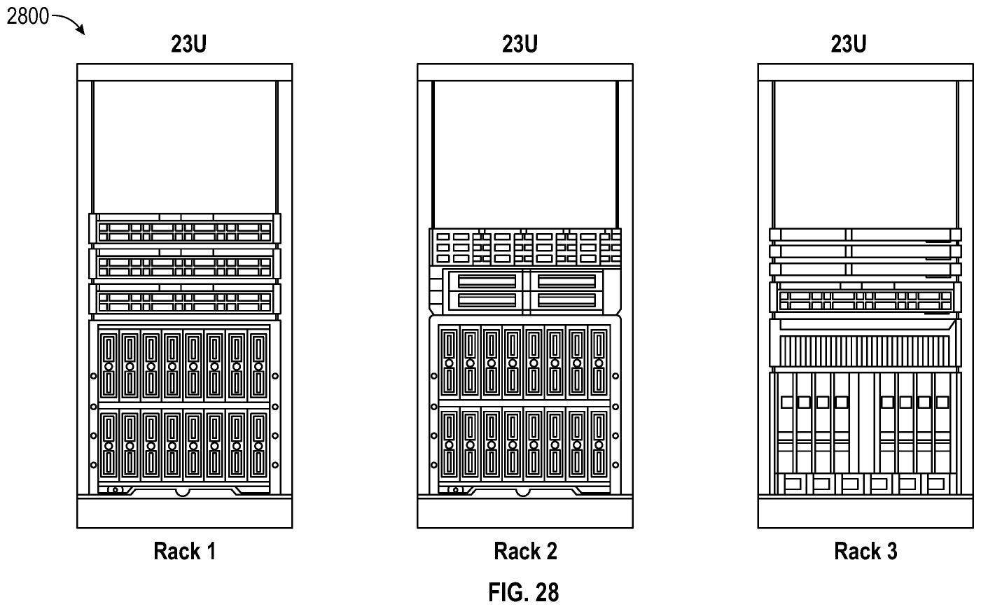

FIGS. 27 and 28 are illustrations of examples of IHS placement recommendations 2700 and 2800, respectively. In these examples, assume that the number of racks in a data center is 3, the size of each rack is 23U, the number of devices is 12 and the devices available are: 2*M1000e (10U each), MX7000 (7U), VRTX (5U), PowerEdge R940 (3U), PowerEdge R740 (2U), 3*PowerEdge R340 (1U each), and cluster of PowerEdge R740 (2U each), such that the total size of all devices is 46U.

Placement suggestion 2700 shows the result of the greedy approach, whereby method 300 fills up Rack 1 initially and then moves on to Rack 2. As all available devices were placed, Rack 3 remains empty. Conversely, placement suggestion 2800 shows the result of the round robin approach, where the devices are evenly distributed across all the available racks.

In sum, systems and methods described herein may provide a solution for device placement suggestions in new and existing datacenters. In some cases, the placement suggestion may involve custom or user-selected physical groups—i.e., if a user selects only 2 racks from the whole set of monitored racks available in a data center, then only the 2 selected racks will be considered for providing placement suggestions.

Moreover, systems and methods described herein may provide consideration of network port availability as a parameter in placement suggestions, in addition to power, space and thermal attributes with considerations for clustered groups. Particularly, these systems and method may consider the clustered devices to be placed together, may consider placement suggestions for rack and chassis based storage devices, may provide placement suggestions for rack and chassis-based network devices, may allow existing rack schemas to be imported into the system and review the current device placements in a data center, and/or may enable one-click physical group creation in power management software by replicating the output of placement suggestions.

As such, systems and methods described herein provide a data center IHS placement suggestions with zero manual intervention. The automatic recommendation engine allows users not to bother about creating an explicit plan on where the devices need to be placed. In some cases, method 300 only needs device model information and the number of units purchased along with few rack parameters as inputs and the final outcome may be a ready-made plan.

In case of existing data centers, power, energy, and other related metrics from device inventory or metric details may be gathered. Maintaining a device specification sheet or file helps to provide device placement suggestions even when the required power and energy metrics are not available from the device. Moreover, a device specification file may provide support for capacity planning with devices whose Unit Size is not available particularly in the case of storage devices and network switches, where the protocol does not typically provide Unit Size details.

Systems and methods described herein may provide an intelligent solution that takes into account data center management guidelines on how the devices should be placed in a rack (e.g., heaviest devices at the bottom and lighter ones at the top). These systems and methods also provide support for clustered devices (e.g., in case of a cluster of servers or a set of MX7000 chassis in Multi Chassis Domain mode, method 300 provides customized placement suggestions by grouping these devices together). Moreover, these systems and methods may provide rack slot recommendation based on network port availability in a TOR switch. Particularly, method 300 considers network availability as a parameter for slot allocation.

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

The terms “tangible” and “non-transitory,” as used herein, are intended to describe a computer-readable storage medium (or “memory”) excluding propagating electromagnetic signals; but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An Information Handling System (IHS), comprising:
a processor; and
a memory coupled to the processor, the memory having program instructions stored thereon that, upon execution, cause the IHS to:
receive user input; and
suggest a location for placement of a plurality of devices in a selected rack of a datacenter based on the user input, wherein the plurality of devices comprise a cluster in which the plurality of devices comprise a group of chassis that function together and are identified as part of the cluster, and wherein the suggested location takes into account a device clustering of the plurality of devices.

2. The IHS of claim 1, wherein the user input comprises: datacenter information and a device list.

3. The IHS of claim 2, wherein state of the datacenter information comprises: new or pre-existing information.

4. The IHS of claim 2, wherein the datacenter information comprises: rack identification, power capacity of each rack, and network port availability of each rack.

5. The IHS of claim 2, wherein the device list comprises at least one of: a device type, a device model, a number of devices, and a service tag.

6. The IHS of claim 5, wherein the device list includes the device type comprising at least one of a monolithic server, a modular server, a network device, a storage enclosure, and a cluster.

7. The IHS of claim 1, wherein the user input further comprises at least one of a greedy approach that considers device placement according to placement on a first selected rack before placement on a second selected rack, and a round-robin approach that suggests the location for the device based on maximum space availability to accommodate the device.

8. The IHS of claim 1, wherein the program instructions upon execution, further cause the IHS to: retrieve a device specification file based upon a service tag obtained from the user input, wherein the device specification file comprises a physical size and a power specification of the device associated with the service tag.

9. The IHS of claim 1, wherein to suggest the location, the program instructions, upon execution, further cause the IHS to:
sort a list of devices by weight or physical size, with the heaviest or largest device being at the bottom of the list, and the lightest or smallest device being at the top of the list; and
select the rack based upon a comparison between the list of the devices and a slot availability of the rack.

10. The IHS of claim 9, wherein to suggest the location, the program instructions, upon execution, further cause the IHS to sum the physical size or weight of two or more of the devices identified as part of the cluster and suggest the location for the cluster in a single rack.

11. The IHS of claim 9, wherein to suggest the location, the program instructions, upon execution, further cause the IHS to:
receive the network port availability from a Top-of-Rack (ToR) switch associated with the selected rack via a command-line (CLI) command; and
verify that network port requirements of the device match the network port availability.

12. A memory storage device having program instructions stored thereon that, upon execution by a processor of an Information Handling System (IHS), cause the IHS to:
receive user input; and
suggest a location for placement of a plurality of devices in a selected rack of a datacenter based on the user input, wherein the plurality of devices comprise a cluster in which the plurality of devices comprise a group of chassis that function together and are identified as part of the cluster, and wherein the suggested location takes into account device clustering of the plurality of devices.

13. The memory storage device of claim 12, wherein the user input comprises: datacenter information and a device list, wherein the datacenter information comprises: rack identification, power capacity of each rack, and network port availability of each rack, and wherein the device list comprises at least one of: a device type, a device model, a number of devices, and a service tag.

14. The memory storage device of claim 12, further comprising retrieving a device specification file based upon a service tag obtained from the user input, wherein the device specification file comprises a physical size and a power specification of the device associated with the service tag.

15. The memory storage device of claim 12, wherein to suggest the location, the program instructions, upon execution, further cause the IHS to:
sort a list of devices by weight or physical size, with the heaviest or largest device being at the bottom of the list, and the lightest or smallest device being at the top of the list; and
select the rack based upon a comparison between the list of the devices and a slot availability of the rack.

16. The memory storage device of claim 15, wherein to suggest the location, the program instructions, upon execution, further cause the IHS to sum the physical size or weight of two or more of the devices identified as part of the cluster and suggest the location for the cluster in a single rack.

17. The memory storage device of claim 16, wherein to suggest the location, the program instructions, upon execution, further cause the IHS to:
receive the network port availability from a Top-of-Rack (ToR) switch associated with the selected rack via a command-line (CLI) command; and
verify that network port requirements of the device match the network port availability.

18. A method, comprising:
receiving user input at an Information Handling System (IHS), wherein the user input comprises: rack identification, power capacity of each rack, a device type, a device model, a number of devices, and a service tag;
retrieving, by the IHS, a device specification file based upon the service tag, wherein the device specification file comprises a physical size and a power specification of the device associated with the service tag;
sorting, by the IHS, a list of devices by weight or physical size, with the heaviest or largest device at the bottom of the list, and the lightest or smallest device at the top of the list;
selecting, by the IHS, the rack based upon a comparison between the list of the devices and a slot availability of the rack; and
suggesting, by the IHS, a location for placement of a plurality of devices in a selected rack of a datacenter based on the user input and the device specification file, wherein the plurality of devices comprise a cluster in which the plurality of devices comprise a group of chassis that function together and are identified as part of the cluster, and wherein the suggested location takes into account device clustering of the plurality of devices.

19. The method of claim 18, wherein suggesting the location further comprises:
receiving the network port availability from a Top-of-Rack (ToR) switch associated with the selected rack via a command-line (CLI) command; and
verifying that network port requirements of the device match the network port availability.

20. The method of claim 18, wherein suggesting the location further comprises summing the physical size or weight of two or more of the devices identified as part of the cluster and suggest the location for the cluster in a single rack.
